(19) United States
(12) Patent Application Publication
(10) Pub. No.: US 2004/0202575 A1
(43) Pub. Date: Oct. 14, 2004

(54) Signal to noise ratio in chromatography

(76) Inventor: Robert W. Allington, Lincoln, NE (US)

Correspondence Address: STURM & FIX LLP, 206 SIXTH AVENUE, SUITE 1213, DES MOINES, IA, 50309-4076, US

(21) Appl. No.: 10/636,153

(22) Filed: Aug. 7, 2003

Related U.S. Application Data
(63) Continuation-in-part of application No. 10/410,373, filed on Apr. 9, 2003.

(51) Int. Cl. G01N 30/02

(52) U.S. Cl. 422/70; 702/25; 422/68.1

(57) ABSTRACT

Signals obtained in capillary High Performance Liquid Chromatography (HPLC) are notoriously noisy. The signal can be improved by increasing the path length of the light passing through the sample stream, but increased path length decreases resolution (resolving N closely spaced peaks in the actual separation into N peaks of almost equal separation on the chromatogram. A novel approach is to utilize a number of photocell sensors lined up along a capillary through which the solution passes. In one embodiment of this invention, the flow of the solution is stopped with the solvent spike oriented with a particular photocell sensor. Then a single, continuous scan or multiple scans of a section of the quiescent solution may be taken and integrated, summed, or statistically correlated. In another embodiment, a solvent spike is detected and tracked. A set of photocell sensors is chosen at increments of time such that the leading photocell is at the solvent spike. The set of photocells is scanned repeatedly. The important information, contained in the integrated, summed or correlated signal, will increase the chromatographic signal relative to the noise information. In this way, the effective path length is increased without including any moving parts or significant loss of resolution.

The present application is a continuation in part of U.S. patent application Ser. No. 10/410,373 which is herein incorporated by reference.

### BACKGROUND OF THE INVENTION

1. Field of the Invention

The present invention relates generally to a method and apparatus for increasing the signal to noise ratio of a signal received from a photocell used in capillary High Performance Liquid Chromatography (HPLC), Capillary Electrophoresis (CE) or Capillary Electroendoosmosis Chromatography (CEC). For instance, in capillary HPLC a capillary tube serves as the chromatographic column. If the capillary is an open tube, its inside diameter may be from 10 μm (detector sensitivity) to 100 μm (detector volume). Packed capillary columns have analogous volume limits.

More particularly the present invention makes use of a plurality of photocells. In one embodiment, the photocells are used to detect a solvent spike (absorbance spike or refractive index spike) of a quiescent fluid. In another embodiment, a set of photocells receive light through the same particle of fluid by accurately tracking the solvent spike as it passes the linear array of photocells. In either case, the signals created by all the photocells are summed or integrated over time to increase the signal to noise ratio. This invention applies to HPLC, CE, and CEC. References herein to capillary chromatography or capillary HPLC may also apply to CEC and CE. “Solvent spike” in the claims and elsewhere includes both relating to an absorbance spike as well as refractive index spikes.

Because the present invention is applicable to HPLC, CE, and CEC, these three will be referred to collectively hereinafter as “capillary separation schemes.” The term “separation schemes” will encompass all the above, plus those used with small volume columns.

2. Background Art

To identify components and their concentration in a mixture of solute and solvent using high performance liquid chromatography, light is passed through the solution. The light that is neither reflected nor absorbed impinges on a photocell, where the intensity of the light is converted to an electrical signal. The intensity of the light hitting the photocell is related to the concentration of a particular solute in the solution. Sensitivity of this system is proportional to the path length of the light as it passes through the sample. Recall that the solution is contained in a capillary tube. Increasing the optical path length in the “usual fashion,” however, invites problems related to widening and “blurring” of peaks because of Poiseulle flow distribution or worse, separation, recirculation, or a flow with a helical path, along the light path.

Sources of noise in the signal include the light source, thermal effects, and turbulence in the flow of the solution. The signal to noise ratio of the signal produced by a single, stationary photocell may be too low to be useful. It becomes difficult or impossible to pick out peaks in the signal because the signal is extraordinarily low and the noise level is as high as in a larger diameter (e.g. 4.7 mm i.d.) chromatographic flow system. A signal to noise ratio of about 2 is considered the lowest acceptable. To overcome this difficulty, it is possible to move the light source and photocell along a capillary tube through which the solute is flowing; or to move the capillary tube past the light source and sensor. The relative velocity at which the capillary tube moves compared to the light source and photocell is equal to the maximum velocity (in any infinitesimally thin slice of fluid in cross-section) of the fluid. The purpose is to generate a “signature” of a particular particle of fluid moving at the centerline speed of the flow. This approach has its weaknesses, including the need for accurately correlating the relative positions of the detector and capillary tube with the peaks observed. The need for moving parts or specially triggered and secondarily detected flash from a flashlamp increases the complexity of the apparatus and the potential for failure.

R. E. McKean, in his University of Massachusetts Ph.D. dissertation “Improving the Signal-to-Noise Ratio by Cross Correlation in Flow Injection Analysis and High Performance Liquid Chromatography” (1990) revealed a method for reducing the signal to noise ratio in high performance liquid chromatography. His approach was to produce a clean (relatively noise free) signal in an artificial setting with high concentrations of the solutes. This clean signal was then cross correlated with the noisy signals produced in the usual settings. Although this approach was successful, it brings up the question of how to produce a clean signal when the solutes are unknown. Also, McKean used chromatography equipment of the late 1980's.

McKean discusses the ensemble averaging of multiple signals to improve the signal to noise ratio. He does not, however, suggest the use of multiple sensors and indicates the averaging approach would be “time consuming” for high performance liquid chromatography, presumably due to needing to run multiple identical samples past a single sensor. McKean, because his research focused on his cross correlation method, was not motivated to utilize multiple sensors for summing or averaging signals in a complete chromatogram.

Another novel approach was suggested by Hjerten in U.S. Pat. No. 5,114,551 in which a single detector was used to pick up a signal at multiple locations on the capillary. This was done by looping the capillary around and returning back to the light source and sensor location. A relatively small improvement in the signal to noise ratio would be realized with this method due to the limited number of chromatograms that can feasibly be taken. In one embodiment of this invention, the capillary tube is moved laterally in order to move a new portion of the capillary tube between the light source and sensor. This is an unnecessary complication, requiring control circuitry and moving parts that can fail. The flow, too, is not favorably enhanced by looping or by moving the capillary tube.

There is, therefore, a need for a way to significantly improve the signal to noise ratio of the signal produced by photocells in capillary high-pressure liquid chromatography with no moving parts.

### SUMMARY OF THE INVENTION

A purpose of this invention is to provide a method and device capable of producing a substantially clean signal in high-pressure liquid chromatography. Another purpose of the present invention is to carry out the aforementioned purpose with no moving parts. As part of these purposes, an objective of the present invention is to accurately track a solvent spike as it flows along its capillary tube.

It is well known that the sensitivity of a chromatograph, produced by any of the capillary separation schemes, HPLC, CE, or, CEC, is directly proportional to the path length of a beam of light passing through the sample. An indirect method of increasing this path length is to repeatedly take a chromatograph of the same particle of solution. A linear array of monochromatic light sources and sensor photocells are aligned parallel with a polished quartz capillary tube. Some of the first photocells encountered by the solvent spike are used to accurately locate the solvent spike, positively identifying a fluid particle. The spike is a relatively large fluid particle about the same size as the injection volume. It arises when the injecting solvent has a refractive index differing from that of the eluting solvent at the same time and location as the injection. Because the scanning tube is a cylinder, the light seen by each photocell varies sharply as the solvent spike (refractive index spike) passes them by. It differs from the absorbance (chromatographic) signal in that the solvent spike is usually taller and arrives first. Therefore it is easy to detect as it is located or goes past any photocell location. In applications involving CE or CEC, and sometimes also capillary HPLC, the solvent spike may be replaced by an unretained, or otherwise leading UV absorbing reference peak. This is accomplished by including a selected absorbance reference material added to the sample. In a first embodiment of the invention, the flow of the solution is stopped within the capillary tube with the solvent spike oriented at a known photocell. The photocell sensors in the linear array are used to scan the solution to obtain a chromatogram for the particular sample. Each photocell will either scan repeatedly, and the scans summed, averaged, or statistically correlated, or the scan will be taken over time and integrated.

In a second embodiment of the invention, the solution flows as usual and a solvent spike in the solution is accurately tracked as it is scanned by a series of photocells in the linear array. Signals from each of the photocells, as the same particle of fluid passes through the associated light beam, are summed or statistically correlated. Because the same particle of solution is being tested, the pertinent information in the signal is the same for each reading. The noise should not be correlated to this method of taking multiple readings. The resulting sum (or average, or statistical correlation) has an improved signal to noise ratio because the signal is strengthened by a factor of N (where N is the number of photocell sensors used to scan a particular fluid particle), while the noise is only strengthened by a factor of \sqrt{N} (assuming white noise).

The novel features believed to be characteristic of this invention, both as to its organization and method of operation together with its further objectives and advantages, will be better understood from the following description considered in connection with the accompanying drawings in which a presently preferred embodiment of the invention is illustrated by way of example. It is to be expressly understood however, that the drawings are for the purpose of illustration and description only and not intended as a definition of the limits of the invention.

### BRIEF DESCRIPTION OF THE DRAWINGS

FIG. 1 shows a light source, capillary tube and photocell sensors.

FIG. 2 shows a flow chart showing steps for carrying out the present invention with a quiescent solution and taking a continuous reading.

FIG. 3 shows a flow chart showing steps for carrying out the present invention with a quiescent solution and taking multiple readings.

FIG. 4 shows how information is carried from an array of photocell sensors, ultimately to a chromatogram when the solution is quiescent during scanning.

FIG. 5 shows a representative clean signal produced by a linear array of 1024 photocell sensors.

FIG. 6 shows a representative noisy signal produced by a linear array of 1024 photocell sensors.

FIG. 7 shows a cleaned signal produced using the methods of the present invention with a linear array of 1024 photocell sensors.

FIG. 8 is a flow chart showing steps for carrying out the present invention with a flowing solution.

FIG. 9 shows how information is carried from an array of photocell sensors, ultimately to a chromatogram when the solution is flowing during scanning.

FIG. 10 shows a representative clean signal produced over time by a photocell sensor.

FIG. 11 shows a representative noisy signal produced over time by a photocell sensor.

FIG. 12 shows a representative cleaned signal produced over time by a photocell sensor.

### BEST MODE FOR CARRYING OUT THE INVENTION

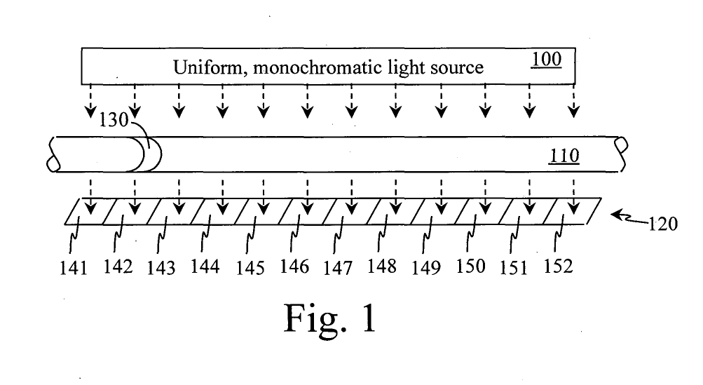

In FIG. 1 a schematic of an apparatus for the present invention is depicted. A uniform, monochromatic light source (or sources) 100 lines one side of a polished, quartz capillary tube 110. Directly opposite (on the other side of the capillary tube 110) is a linear array of photocell sensors 120. (Only twelve individual photocell sensors 141-152 are shown in FIG. 1, however, in practice many more individual photocell sensors 141-152 would be used.) Some of the light emitted from the light source 100 is reflected off the capillary tube 110 and the solution flowing through the capillary tube. Some of the light is absorbed by the solution. That light not reflected or absorbed, passes through the capillary tube 110 and the solution flowing in the capillary tube. Each of the photocell sensors 141-152 creates a signal related to the light intensity of the light that impinges on it. An identifying feature of the components of the solution is the amount of light absorbed.

A signal of interest is one over a period of time. A fluid particle 130 is defined as a small mass of fluid of fixed identity. As a fluid particle 130 of the solution is scanned by a photocell 141-152, a signal is recorded based on the light passing through the fluid particle 130 and impinging on the photocell sensor 141-152.

In the first embodiment of the present invention, the fluid is quiescent when the scanning step is carried out. Therefore, any given photocell 141-152 records data for a single fluid particle 130. The data recorded might be an integral of each individual photocell's 141-152 signal over time, or a summation, average or statistical correlation of a series of the photocell's 141-152 signals taken sequentially over time.

In the second embodiment of the present invention, the same particle of fluid 130 travels past each of the photocell sensors 141-152 in turn. The velocity of the fluid particle 130 is determined as follows. A location of a solvent spike is detected using the first photocell sensors 141-152 the solvent spike encounters. For instance, 1000 photocell sensors 141-152 in an array 120 of 2048 photocell sensors may be used to detect a solvent spike. It is known that the solvent spike is a fluid particle about the same size as the injection volume. The solvent spike is formed when the injecting solvent has a refractive index differing from that of the eluting solvent at the same time and location as the injection. The light detected by each photocell sensor 141-152 varies sharply as the solvent spike (refractive index spike) passes between the light source 100 and a photocell sensor 141-152. The signal produced by a photocell sensor 141-152 when the solvent spike is scanned differs from the absorbance (chromatographic) signal in that the signal due to the solvent spike is usually taller and arrives before other peaks. The said spike may also be an absorbance spike. Once the spike has been detected, its velocity is determined using a small number of additional photocell sensors 141-152, for instance, as the spike passes from the 1000^{th} photocell sensor to the 1005^{th} photocell sensor. This velocity, in photocell sensors per unit time, is multiplied by a predetermined factor, for example 1001, to obtain a scanning speed, again in photocells per unit time.

Using this scanning speed, a number of photocell sensors 141-152 equal to the predetermined factor (e.g. 1001) are scanned. Using the example, above, the 6^{th} through the 1006^{th} photocell sensors are scanned. At the end of this scan, the solvent spike is again located using the data just obtained from the photocell sensor scan. The solvent spike should be at the last photocell sensor from which data were obtained. According to our example, the solvent spike should be located at the 1006^{th} photocell sensor. If the solvent spike is not located at the correct sensor, the solvent spike velocity is recalculated from the new data, a new scanning velocity is calculated and the process repeated using the correct bank of photocell sensors 141-152. In our example, this new correct bank of photocell sensors 141-152 for the next step would be the 7^{th} through the 1007^{th} photocell sensors.

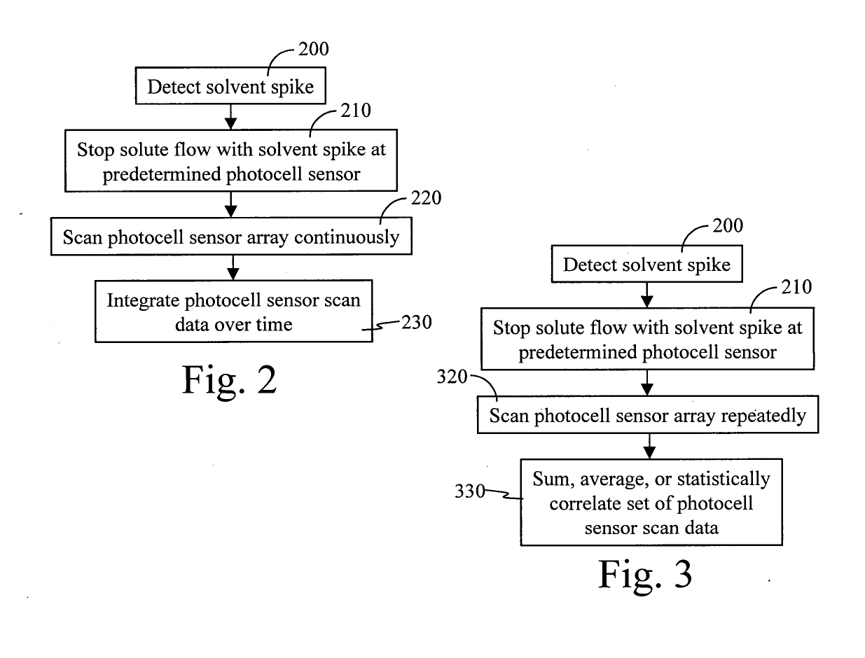

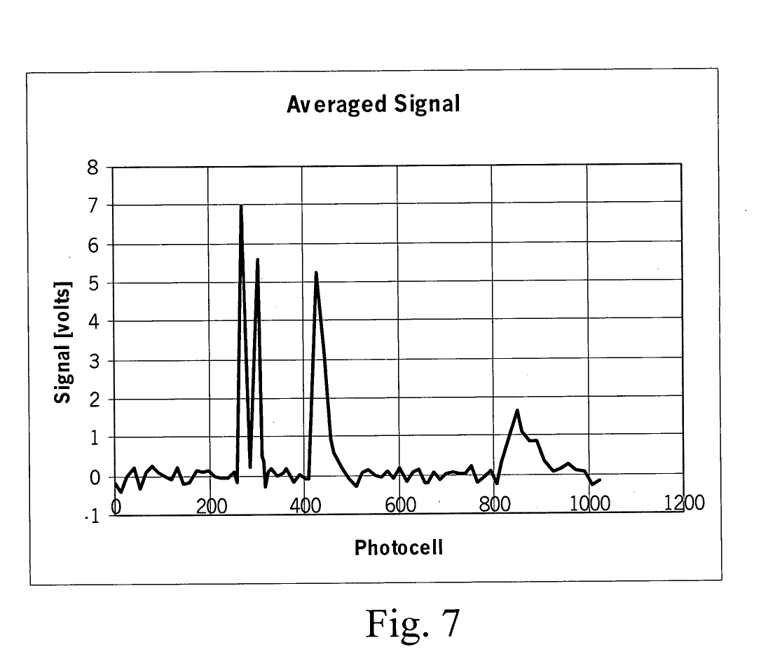

FIGS. 2 and 3 depict flow diagrams for the first embodiment wherein the solute is quiescent when scanned. Initially, the solute is pumped into the capillary tube 110. The location of the solvent spike is detected 200 as the solute flows in the same manner as described above. When the solvent spike arrives at a predetermined photocell sensor 141-152, for example the 1000^{th} in an array 120 of 1024 photocell sensors, the solute flow is stopped 210, either by stopping the pump or by closing a valve. With the solute in a quiescent state, and the solvent spike located at a known photocell sensor 141-152, all the photocell sensors 141-152 in the array 120, or a predetermined subset of the photocell array 120, are scanned continuously 220 (FIG. 2) for a predetermined duration. The result of this continuous scan is integrated 230 in the photocell sensor 141-152 if its charge storage capacity is adequate, or in a separate integrator for each photocell sensor 141-152. The resulting information is a plot of the light passing through the capillary tube 110 with the independent variable (abscissa) being the photocell number from which the signal was taken (see FIG. 7). This abscissa can easily be converted to the location along the capillary tube 110, x, if preferred.

In FIG. 3, the same approach as that shown in FIG. 2 is taken, except that instead of a continuous scan 220, scans are taken repeatedly 320 and then summed, averaged, or statistically correlated 330 to produce the reduced-noise signal.

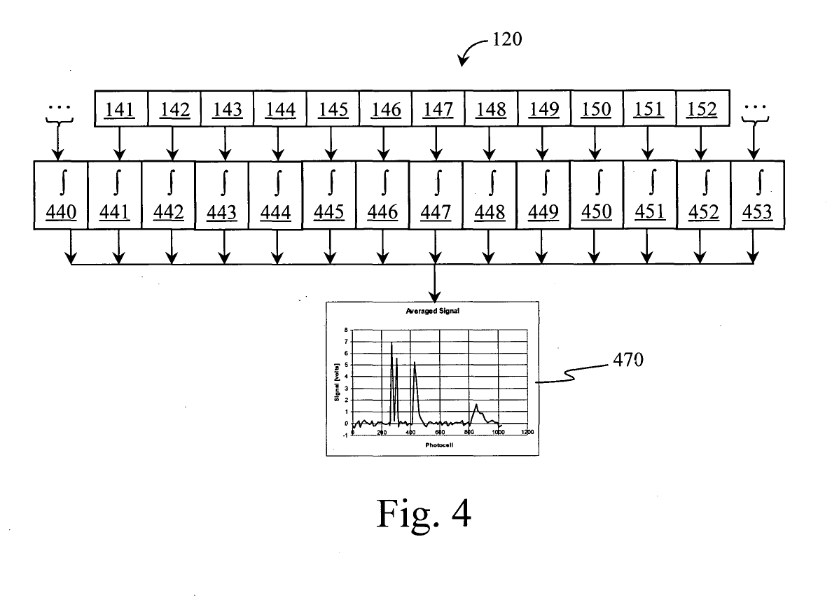

The process of scanning, calculating, and storing the data is depicted in FIG. 4. The linear photocell sensor array 120 is shown at the top with twelve photocell sensors 141-152 shown. The ellipses shown to the left of photocell sensor 141 and to the right of photocell sensor 152 indicate there may be more photocell sensors.

The signal from each of the photocell sensors is fed into a set of processing blocks 440-453. These processing blocks 440-453 may include an Analog to Digital (A/D) converter and an integration, summation, or statistical correlation function. The processing blocks 440-453 may be inherent to the photocells, themselves, if the charge storage capacity of each photocell sensor is adequate for the task, or they may be separate units, carrying out their operations in analog or digital mode. Finally, the resulting, processed data are organized into a chromatogram, as indicated by the plot 470 shown.

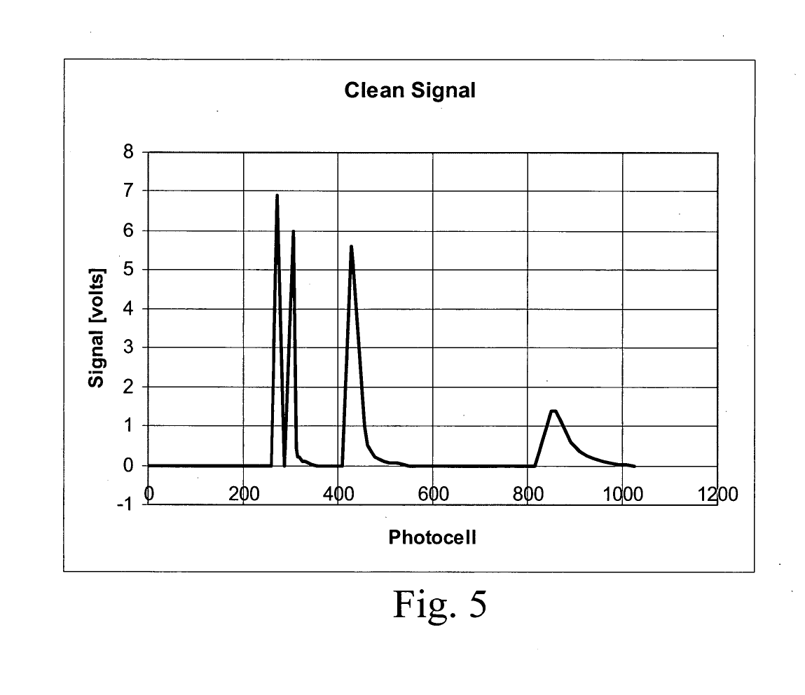

A representative plot of a scan is shown in FIG. 5. This plot shows a noise-free signal of the quiescent solution as taken from 1024 photocells. Here, four peaks or spikes are shown. On the abscissa is the photocell sensor number from 1 to 1024, while the ordinate is the signal, as amplified from the photovoltaic sensors, in volts.

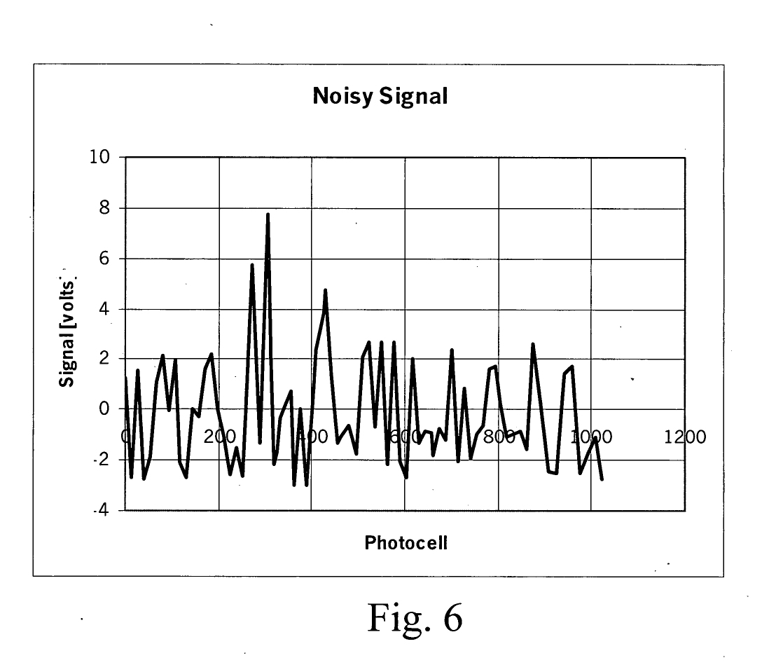

In FIG. 6 the noise-free signal is shown with white noise superimposed upon it, resulting in a noisy signal. The white noise has a maximum amplitude of three volts. The clean signal cannot be identified due to the noise.

In FIG. 7, 100 noisy signals like that shown in FIG. 6 have been integrated with the time of integration divided out, or arithmetically averaged, or statistically correlated. As can easily be seen, due to the averaging step, the relative fraction of the signal attributable to noise is greatly reduced.

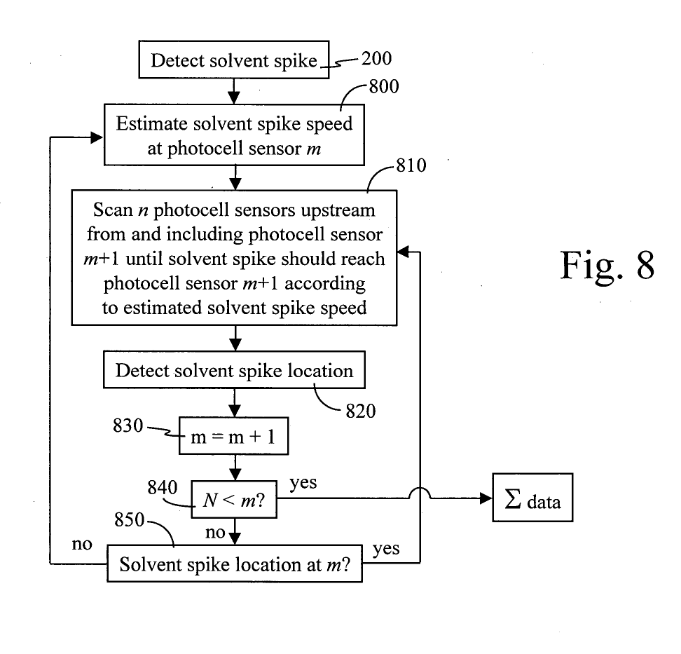

A flow diagram of the second embodiment of the present invention is shown in FIG. 8. Once the solvent spike is detected 200, its speed, Vₛₛ, is estimated 800 at photocell sensor m, such as the 1005^{th} photocell sensor, as used in the example, above. Then the n (n=1001 in the above example) photocell sensors from m+1 “back” (upstream) are scanned at a rate, Vₛᵣ, such that, when the scan is finished, the solvent spike should have reached photocell sensor m+1 810. The scanning speed is calculated as Vₛᵣ=nVₛₛ, where both Vₛᵣ and Vₛₛ are in photocells per unit time.

After the aforementioned scan 810, the location of the solvent spike is, again, detected 820, ultimately to ascertain that it did, in fact, reach photocell sensor m+1, and no further. Before comparing the location of the solvent spike to photocell sensor m+1, the value of m is incremented up by one (1.0) 830 and this new value of m is tested 840 against N, the total number of photocell sensors 141-152 (2048 in the example above), so the process ends when the last photocell sensor is encountered. If m≦N at this point, the location of the solvent spike is compared 850 with the location of the photocell sensor m. If the solvent spike is at photocell sensor m, the same estimated solvent spike speed is used and the process repeated, scanning n photocell sensors upstream from and including the new photocell sensor m+1 810. If the solvent spike is not at photocell sensor m, a new solvent spike speed is estimated 800 before the remainder of the process is repeated as before.

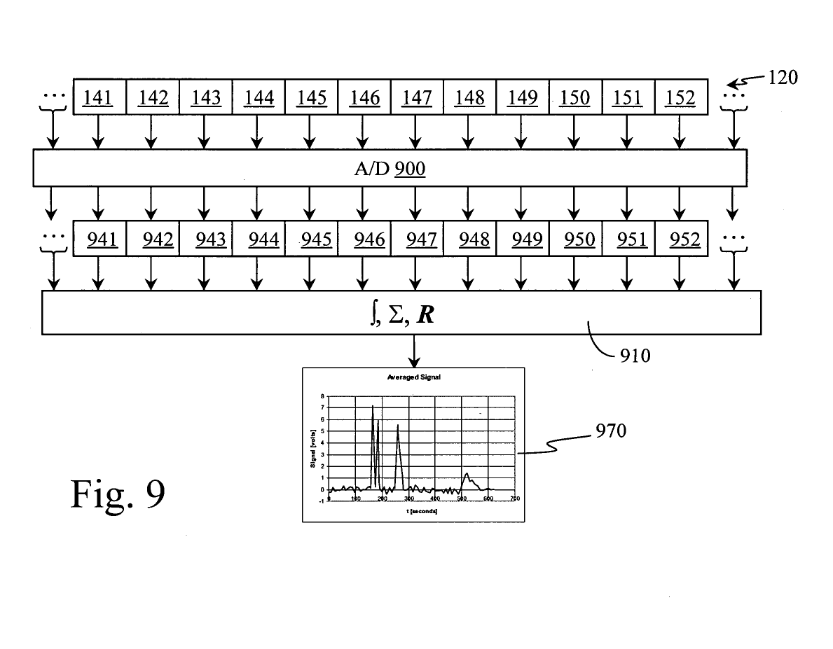

For the present embodiment wherein measurements are made of the flowing solution, the photocell sensors 141-152 are again shown in FIG. 9 with ellipses shown at each end of the linear array 120 to indicate there may be more photocell sensors than shown. The analog signals from the photocell sensors 141-152 are converted to digital signals in an AID converter 900. Because the front of the n photocell sensors is shifted such that it moves with the flow, and only n photocell sensors are read at each scan, the digital signals, from the first to the last, need only to be stored in memory locations 941-952 from the first to the last. No more shifting is required.

From the memory locations 941-952, the signal is processed in a calculation function 910 that integrates, sums or statistically correlates each photocell sensors' 141-152 signal to produce a chromatogram, as indicated by the plot 970.

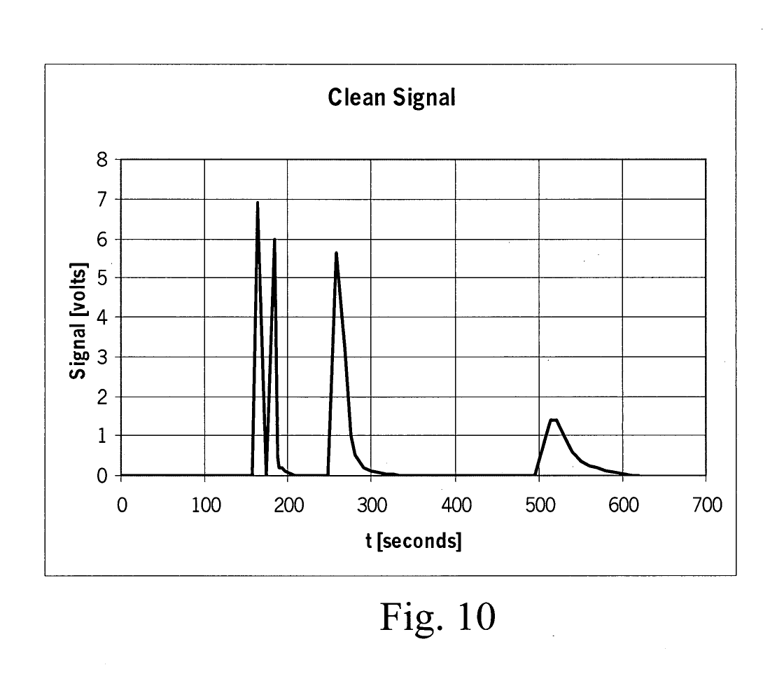

A chromatogram, such as would be produced by the second embodiment of the present invention, is shown in FIG. 10. FIG. 10 represents a clean (noiseless) HPLC with four peaks. Although the abscissa could be the photocell numbers of the n photocell sensors used for each scan, it is just as logical to make the abscissa be time in seconds. The ordinate is, again, the signal, as amplified from the photovoltaic sensors, in volts.

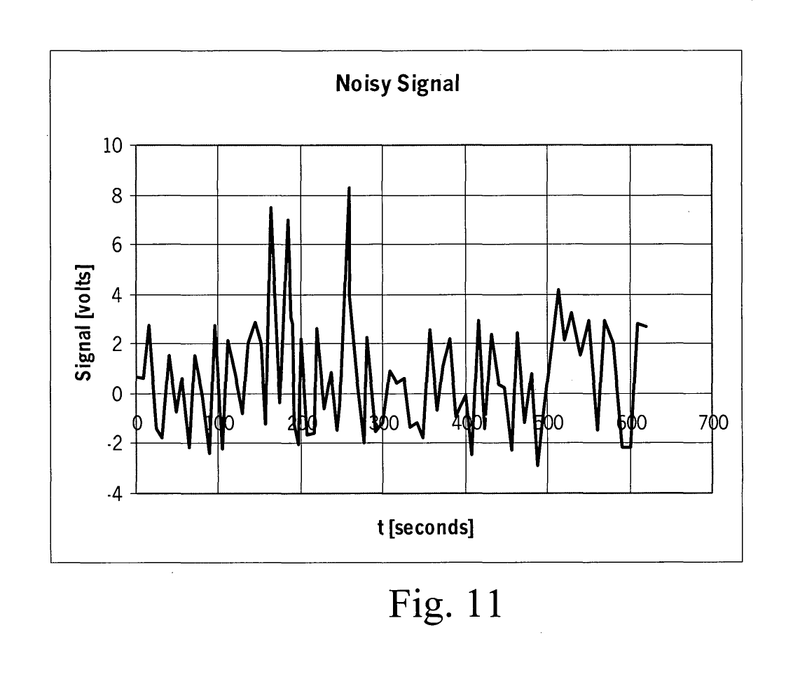

The same signal as shown in FIG. 10 is replotted in FIG. 11 with simulated noise superimposed on the clean signal. The white noise has a maximum amplitude of three volts. The clean signal cannot be identified due to the noise.

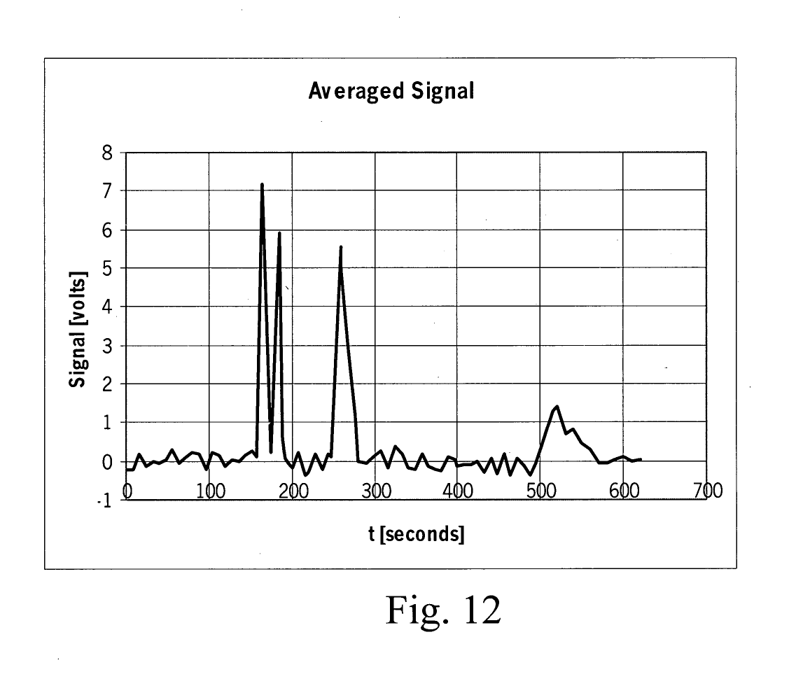

The next step in the analysis is shown in FIG. 12. Here, 100 noisy signals, with the same clean content as shown in FIG. 10 and different noise (all with a maximum amplitude of three volts), were averaged. The improvement can easily be seen when comparing FIG. 12 with FIG. 11. The improvement is evident, even though only 100 readings were used (in practice, many more could be used). Even the last and smallest peak (seen in FIG. 10 at about 515 seconds) can be resolved from the noise. The signal could also have been summed or statistically correlated.

Obviously many modifications and variations of the present invention are possible in light of the above teachings. Any number of photocell sensors may be used in the linear arrays. The photocell sensor array need not be linear. It is, therefore, to be understood that within the scope of the appended claims, the invention may be practiced otherwise than as specifically described.

I claim:

1. A method for improving a quality of a signal in a separation scheme by employing a plurality of stationary sensors, the method comprising:
(a) sensing information about a fluid particle with at least some of the plurality of stationary sensors and producing at least one signal for each stationary sensor used, based on said information;
(b) operating on the signals using an operation selected from a group consisting of integration, summation, and statistical correlation to create a signal with greater signal to noise ratio than any of the individual plurality of signals; and
(c) using said signal with greater signal to noise ratio to produce a chromatogram.

2. The method of claim 1 wherein additional information is sensed about a plurality of fluid particles, said additional information being combined to produce a chromatogram.

3. The method of claim 1 wherein the fluid particle flows in a capillary tube along which the plurality of sensors is arrayed, and wherein the step of sensing information about a fluid particle with at least some of the plurality of stationary sensors comprises the steps of:
(a) selecting a first sensor when the fluid particle is located adjacent to said first sensor;
(b) sensing information about the fluid particle with the first sensor;
(c) selecting a second sensor when the fluid particle is no longer located adjacent to the first sensor but is adjacent to the second sensor; and
(d) sensing information about the fluid particle with the second sensor.

4. The method of claim 3 wherein the location of the fluid particle is determined by detecting a marker spike.

5. The method of claim 4 wherein the marker spike arises from a difference between a refractive index between a sample solvent and a separation solvent.

6. The method of claim 4 wherein the marker spike arises from a spike reproducibly related to at least one separated peak.

7. The method of claim 4 wherein the marker spike, reproducibly related to a separated peak, is upstream of all sample peaks in the separation.

8. The method of claim 4 wherein the marker spike is an absorbance spike.

9. The method of claim 8 wherein the marker spike is generated by adding an absorbance marker with a reproducible relationship to a location of the sample injection.

10. The method of claim 8 wherein the marker spike is generated by adding an absorbance marker with a reproducible relationship to a timing of a sample injection.

11. The method of claim 10 wherein the absorbance spike arises from an absorbance marker added in a solvent.

12. The method of claim 3 wherein a second plurality of sensors sense information about additional fluid particles during a time when the fluid particle is adjacent to the first sensor.

13. The method of claim 12 wherein a number of the second plurality of sensors is predetermined.

14. The method of claim 12 wherein the sensed information from the second plurality of sensors is assembled into a chromatogram.

15. The method of claim 1 wherein the plurality of sensors are photocell sensors.

16. A method for improving a quality of a signal in a fluid-based separation scheme by employing a plurality of stationary sensors, the method comprising:
(a) stopping a fluid solution adjacent to the plurality of stationary sensors;
(b) sensing information about the solution with at least some of the plurality of stationary sensors;
(c) operating on signals from each of the at least some of the plurality of stationary sensors using an operation selected from a group consisting of integration, summation, and statistical correlation to create a signal with greater signal to noise ratio than any of the individual plurality of signals; and
(d) using said signal with greater signal to noise ratio to produce a chromatogram.

17. The method of claim 16 wherein the step of stopping the fluid solution comprises the steps of:
(a) detecting a solvent spike in the solution;
(b) tracking said solvent spike as it moves; and
(c) stopping the solvent spike in the neighborhood of a predetermined photocell sensor.

18. The method of claim 16 wherein a predetermined number of sensors are used as the at least some of the plurality of sensors.

19. The method of claim 16 wherein the operated on signals are assembled into a chromatogram.

20. The method of claim 16 wherein the plurality of sensors are photocell sensors.

21. An apparatus for improving a quality of a signal in a fluid-based separation scheme, the apparatus comprising:
(a) a plurality of stationary sensors for sensing information about a fluid particle; and
(b) at least one calculation unit operating on the signals using an operation selected from a group consisting of integration, summation, and statistical correlation to create a signal with greater signal to noise ratio than any of the individual plurality of signals.

22. The apparatus of claim 21 wherein additional information is sensed about a plurality of fluid particles, the apparatus additionally comprising means for combining said additional information to produce a chromatogram.

23. The apparatus of claim 21 wherein the fluid particle flows in a capillary tube along which the plurality of sensors is arrayed, and wherein sensing information about a fluid particle with the plurality of stationary sensors is accomplished with apparatus comprising:
(a) a first selector for selecting a first sensor when the fluid particle is located adjacent to said first sensor; and
(b) a second selector for selecting a second sensor when the fluid particle is no longer located adjacent to the first sensor but is adjacent to the second sensor.

24. The apparatus of claim 23 additionally comprising means for determining the location of the fluid particle by detecting a solvent spike.

25. The apparatus of claim 23 additionally comprising a second plurality of sensors to sense information about additional fluid particles during a time when the fluid particle is adjacent to the first sensor.

26. The apparatus of claim 25 including means to predetermine a quantity of the second plurality of sensors.

27. The apparatus of claim 25 including means for assembling the sensed information from the second plurality of sensors into a chromatogram.

28. The apparatus of claim 21 wherein the plurality of sensors are photocell sensors.

29. An apparatus for improving a quality of a signal in a capillary separation scheme by employing a plurality of stationary sensors, the apparatus comprising:
(a) means for stopping a flow of a solution adjacent to the plurality of stationary sensors;
(b) sensors for sensing information about the solution with at least some of the plurality of stationary sensors; and
(c) at least one calculation unit operating on signals from each of the at least some of the plurality of stationary sensors using an operation selected from a group consisting of integration, summation, and statistical correlation to create a signal with greater signal to noise ratio than any of the individual plurality of signals.

30. The apparatus of claim 29 wherein determining an appropriate stopping point for the flow of the solution comprises the steps of:
(a) means for detecting a solvent spike in the solution;
(b) means for tracking said solvent spike as it flows; and
(c) means for stopping the solvent spike at a predetermined photocell sensor.

31. The apparatus of claim 29 including a means for determining a predetermined quantity of sensors to be used as the at least some of the plurality of sensors.

32. The apparatus of claim 29 including means to assemble the operated on signals into a chromatogram.

33. The apparatus of claim 29 wherein the plurality of sensors are photocell sensors.
